(19) United States
(12) Patent Application Publication
(10) Pub. No.: US 2006/0091775 A1
(43) Pub. Date: May 4, 2006

(54) Vehicle headlamp

(75) Inventors: Frank Auer, Bolheim (DE); Klaus Wittmann, Sontheim (DE); Sascha Zelt, Ulm (DE)

Correspondence Address: OSRAM SYLVANIA INC, 100 ENDICOTT STREET, DANVERS, MA, 01923, US

(73) Assignee: PATENT-TREUHAND-GESELLSCHAFT FÜR ELEKTRISCH GLÜHLAMPEN MBH, MUNCHEN (DE)

(21) Appl. No.: 11/259,107

(22) Filed: Oct. 27, 2005

(30) Foreign Application Priority Data
Nov. 3, 2004 (DE) 102004053644.9

(51) Int. Cl. H01J 5/50; H01J 61/36; H01J 17/18

(52) U.S. Cl. 313/331; 313/623; 313/624

(57) ABSTRACT

A vehicle headlamp has a first incandescent filament, which is preferably used to generate a main beam, and a second incandescent filament, which is preferably used to generate daytime running light, the incandescent filaments being fixed within a lamp vessel—which is provided with a lamp base—using three supply lead wires, which are arranged in a common plane, with the result that they are arranged one above the other when the vehicle headlamp is suitably oriented, the bottom supply lead wire and the top supply lead wire being used to fix the first incandescent filament and the top supply lead wire and the middle supply lead wire being used to arrange the second incandescent filament such that it is offset in a parallel manner with respect to the axis of the first incandescent filament and is above the axis of the first incandescent filament.

### I. TECHNICAL FIELD

The invention relates to a vehicle headlamp having a first incandescent filament and a second incandescent filament, the incandescent filaments being fixed within a lamp vessel—which is provided with a lamp base—using three supply lead wires.

### II. BACKGROUND ART

A vehicle headlamp of this type is disclosed, for example, in EP-A 1 089 324. This document describes a vehicle headlamp having a first incandescent filament for generating a main beam and a second incandescent filament for generating daytime running light, the incandescent filaments being fixed, such that they are aligned coaxially, within a lamp vessel using three supply lead wires. It has been found that the daytime running light and main beam functions can be provided in an improved manner using vehicle headlamps in which, instead of the two incandescent filaments being aligned coaxially as mentioned above, these incandescent filaments are arranged such that they are offset in a parallel manner.

### III. DISCLOSURE OF THE INVENTION

The object of the invention is to provide a vehicle headlamp of the generic type having improved suspension of the incandescent filaments.

According to the invention, this object is achieved by means of a vehicle headlamp having a first incandescent filament and a second incandescent filament, the incandescent filaments being fixed within a lamp vessel—which is provided with a lamp base—using three supply lead wires, wherein the three supply lead wires are arranged in a common plane, with the result that they are arranged one above the other when the vehicle headlamp is suitably oriented, the bottom supply lead wire and the top supply lead wire being used to fix the first incandescent filament and the top supply lead wire and the middle supply lead wire being used to arrange the second incandescent filament such that it is offset in a parallel manner with respect to the axis of the first incandescent filament and is above the axis of the first incandescent filament. Particularly advantageous embodiments of the invention are described in the dependent patent claims.

The vehicle headlamp according to the invention has a first incandescent filament, which is preferably used to generate a main beam, and a second incandescent filament, which is preferably used to generate daytime running light, the incandescent filaments being fixed within a lamp vessel—which is provided with a lamp base—using three supply lead wires which are arranged one above the other in a common plane when the vehicle headlamp is suitably oriented, with the result that the bottom supply lead wire and the top supply lead wire are used to fix the first incandescent filament and the top supply lead wire and the middle supply lead wire are used to arrange the second incandescent filament such that it is offset in a parallel manner with respect to the axis of the first incandescent filament and is above the axis of the first incandescent filament. Arranging the supply lead wires and the two incandescent filaments in the abovementioned manner makes it possible to ensure in a simple manner that the second incandescent filament is arranged such that it is offset in a parallel manner with respect to, and is above, the axis of the first incandescent filament, at a prescribable distance. FIG. 2 illustrates the abovementioned suitable orientation of the vehicle headlamp. It corresponds to one preferred operating position of the vehicle headlamp according to the invention. For reasons of easier understanding, the terminology used here to describe the invention is linked to this orientation of the lamp that is shown in FIG. 2. However, the vehicle headlamp according to the invention can also be operated in any desired other operating positions.

In order to minimize light shading effects caused by the supply lead wires, in particular by the middle supply lead wire, the first filament outgoing feeder—which faces the lamp base and is close to the base—of the second incandescent filament is advantageously connected to the middle supply lead wire and the second filament outgoing feeder—which faces away from the lamp base and is remote from the base—of the second incandescent filament is connected to the top supply lead wire.

That end of the middle supply lead wire which is connected to a filament outgoing feeder, preferably the filament outgoing feeder which is close to the base, of the second incandescent filament is advantageously bent in order to be able to set the degree of parallel offset between the two incandescent filaments within narrow limits.

The second incandescent filament is preferably in the form of a single-coiled incandescent filament whose coiled section has a length of 4.2 mm±0.3 mm and an external diameter of 0.76 mm±0.05 mm and has 29±3 turns in order to ensure a power consumption in the range of 17 W to 22 W given a supply voltage of 13.2 volts.

The first incandescent filament is preferably partially surrounded by a shading apparatus in order to generate the main beam.

In accordance with the preferred exemplary embodiment of the invention, a first filament outgoing feeder of the first incandescent filament is connected to the top supply lead wire, its second filament outgoing feeder is connected to the shading apparatus, the first filament outgoing feeder—which faces the lamp base of the vehicle headlamp and is close to the base—of the second incandescent filament is connected to the middle supply lead wire and the second filament outgoing feeder—which faces away from the lamp base and is remote from the base—of the second incandescent filament is connected to the top supply lead wire. As a result, one of the supply lead wires is used exclusively to fix the shading apparatus and to contact-connect that filament outgoing feeder of the first incandescent filament which is connected to the shading apparatus. The other filament outgoing feeder of the first incandescent filament and the filament outgoing feeders of the second incandescent filament are preferably connected to the other two supply lead wires.

### IV. BRIEF DESCRIPTION OF THE DRAWINGS

The invention will be explained in more detail below with reference to a preferred exemplary embodiment. In the drawing:

FIG. 1 shows a diagrammatic illustration of the filament suspension of the preferred exemplary embodiment of the vehicle headlamp according to the invention, and

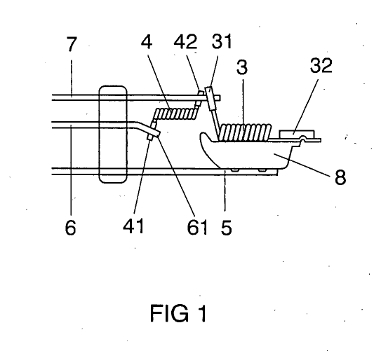

FIG. 2 shows a diagrammatic illustration of a side view of the preferred exemplary embodiment of the vehicle headlamp according to the invention.

### V. BEST MODE FOR CARRYING OUT THE INVENTION

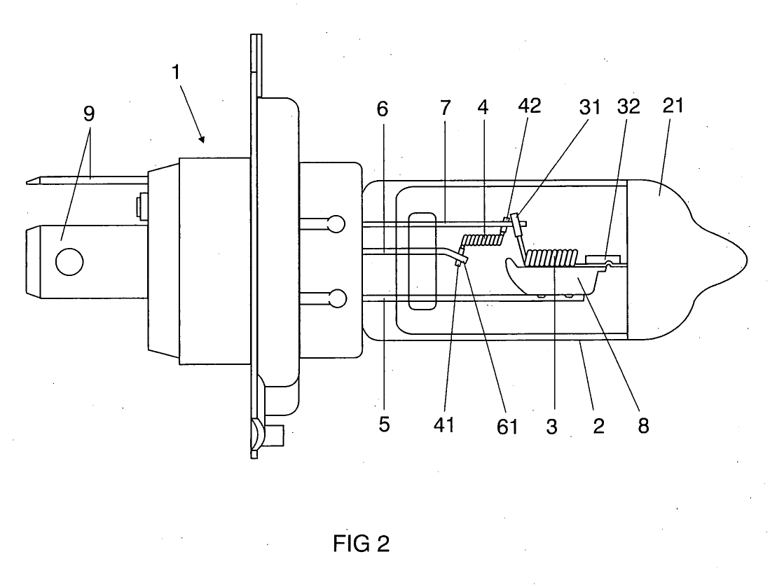

The preferred exemplary embodiment (depicted in FIG. 2) of the invention is a halogen incandescent lamp for a vehicle headlight. It is intended to be operated using the vehicle electrical system voltage of a motor vehicle. This vehicle headlamp has a vitreous lamp vessel 2 which is provided with a lamp base 1 and is essentially axially symmetrical. Arranged within the lamp vessel 2 are two incandescent filaments 3, 4 which are electrically contact-connected and fixed using three supply lead wires 5, 6 and 7. Each of the supply lead wires 5 to 7 is routed out of the sealed end of the lamp vessel 2 and is respectively connected to an electrical connection 9 of the lamp base 1 in an electrically conductive manner. The other end of the lamp vessel 2, that is to say the dome of the lamp vessel 2, is provided with an opaque coating 21. The three supply lead wires 5, 6 and 7 are arranged in a common plane and the vehicle headlamp is oriented during operation in such a manner that the three supply lead wires 5 to 7 are arranged one above the other. The first incandescent filament 3 which is used to generate the main beam is designed for an electrical power level in the range of 55 watts to 75 watts given a supply voltage of 13.2 volts. The first filament outgoing feeder 31 (which is close to the base) of the first incandescent filament 3 is connected to the top supply lead wire 7. The second filament outgoing feeder 32 (which is remote from the base) of the first incandescent filament 3 is connected to a metallic anti-dazzle device 8 that partially surrounds the first incandescent filament 3. The anti-dazzle device 8 is, for its part, welded to the bottom supply lead wire 5, with the result that the first incandescent filament 3 is electrically contact-connected by means of the supply lead wires 5 and 7 and the anti-dazzle device 8.

The second incandescent filament 4 which is used to generate daytime running light is designed for an electrical power level in the range of approximately 17 watts to 22 watts given a supply voltage of 13.2 volts. This incandescent filament 4 is in the form of a single-coiled incandescent filament whose coiled section has a length of 4.2 mm and an external diameter of 0.76 mm and has 29 turns. The first filament outgoing feeder 41 (which is close to the base) of the second incandescent filament 4 is connected to the downwardly bent end 61 of the middle supply lead wire 6. The second filament outgoing feeder 42 (which is remote from the base) of the second incandescent filament 4 is connected to the top supply lead wire 7.

The winding axes of the two incandescent filaments 3, 4 are arranged such that they are offset in a parallel manner by approximately 2 mm. The axis of the first incandescent filament 3 essentially runs along the axis of the lamp vessel 2, while the axis of the second incandescent filament 4 is arranged approximately 2 mm above the lamp vessel axis and the axis of the first incandescent filament 3.

The incandescent filaments 3 and 4 are usually composed of tungsten, while the supply lead wires 5, 6 and 7 and the anti-dazzle device 8 are manufactured from molybdenum. The filament outgoing feeders 31, 32, 41 and 42 of the incandescent filaments 3 and 4 are connected to the supply lead wires 5 to 7 and to the anti-dazzle device 8, respectively, in the conventional manner, for example, using molybdenum tubes which surround the filament outgoing feeders with a clamping fit and are welded to the supply lead wires and to the anti-dazzle device.

The invention is not restricted to the exemplary embodiment explained in more detail above. By way of example, it is possible to dispense with the opaque coating 21 on the lamp vessel dome. It is likewise possible to dispense with the bent end 61 of the middle supply lead wire 6. In addition, the invention may also be applied to other types of two-filament lamps.

1. A vehicle headlamp having a first incandescent filament and a second incandescent filament, the incandescent filaments being fixed within a lamp vessel—which is provided with a lamp base—using three supply lead wires, wherein the three supply lead wires are arranged in a common plane, with the result that they are arranged one above the other when the vehicle headlamp is suitably oriented, the bottom supply lead wire and the top supply lead wire being used to fix the first incandescent filament and the top supply lead wire and the middle supply lead wire being used to arrange the second incandescent filament such that it is offset in a parallel manner with respect to the axis of the first incandescent filament and is above the axis of the first incandescent filament.

2. The vehicle headlamp as claimed in claim 1, wherein the first filament outgoing feeder—which faces the lamp base of the vehicle headlamp and is close to the base—of the second incandescent filament is connected to the middle supply lead wire and the second filament outgoing feeder—which faces away from the lamp base and is remote from the base—of the second incandescent filament is connected to the top supply lead wire.

3. The vehicle headlamp as claimed in claim 1, wherein the middle supply lead wire has a bent end that is connected to a filament outgoing feeder of the second incandescent filament.

4. The vehicle headlamp as claimed in claim 1, wherein a shading apparatus is provided for the first incandescent filament, said shading apparatus being fixed to the bottom supply lead wire.

5. The vehicle headlamp as claimed in claim 4, wherein a first filament outgoing feeder of the first incandescent filament is connected to the top supply lead wire, its second filament outgoing feeder is connected to the shading apparatus, the first filament outgoing feeder—which faces the lamp base (1) of the vehicle headlamp and is close to the base—of the second incandescent filament is connected to the middle supply lead wire and the second filament outgoing feeder—which faces away from the lamp base (1) and is remote from the base—of the second incandescent filament is connected to the top supply lead wire.

6. The vehicle headlamp as claimed in claim 1, wherein the second incandescent filament is in the form of a single-coiled incandescent filament whose coiled section has a length of 4.2 mm±0.3 mm and an external diameter of 0.76 mm±0.05 mm and has 29±3 turns.

7. The vehicle headlamp as claimed in claim 1, wherein one incandescent filament is in the form of a main beam incandescent filament and the other incandescent filament is in the form of a daytime running light incandescent filament.

8. The vehicle headlamp as claimed in claim 2, wherein the middle supply lead wire has a bent end that is connected to a filament outgoing feeder of the second incandescent filament.
